(19) United States
(12) Patent Application Publication
(10) Pub. No.: US 2002/0032873 A1
(43) Pub. Date: Mar. 14, 2002

(54) Method and system for protecting objects distributed over a network

(76) Inventors: David A. Lordemann, Los Altos, CA (US); Daniel J. Robinson, Santa Clara, CA (US); Paul O. Scheibe, Woodside, CA (US)

Correspondence Address: LAW OFFICE OF THOMAS SCHNECK, P.O. BOX 2-E, SAN JOSE, CA, 95109-0005, US

(21) Appl. No.: 09/952,290

(22) Filed: Sep. 13, 2001

Related U.S. Application Data
(60) Provisional application No. 60/232,599, filed on Sep. 14, 2000.

(51) Int. Cl. H04L 9/00

(52) U.S. Cl. 713/201

(57) ABSTRACT

A method and system for protecting objects stored on network servers are presented. An object server runs computer software that designates which objects are to be protected and the security policy for that object. If the object server receives a request for a protected object, the object server creates an enhanced request containing encrypted data related to the request and the requested object; this enhanced request is redirected to a security server which authenticates the request, retrieves the requested object, encrypts the object using a one-time encryption key, and combines the encrypted object with mobile code, the security policy, and object controls to implement the policy. This package is then sent to the requester, which executes the mobile code, resulting in the instantiation of the security policy and object controls on the requester computer. The mobile code will execute tests to ensure proper instantiation of the object controls. A one-time decryption key may be requested by and provided to the requester providing the object controls were properly instantiated. The requested object is rendered subject to the security policy and object controls.

### Cross-Reference to Related Application

This application claims priority from U.S. provisional application no. 60/232,599, filed Sep. 14, 2000.

### FIELD OF THE INVENTION

This invention is related to protecting objects such as code, documents, and images that are distributed over a network, particularly those exchanges that take place according to the Hypertext Transfer Protocol.

### BACKGROUND OF THE INVENTION

The Internet is now commonly used in the course of business to search for information and exchange code, documents, images, etc. among collaborators, prospective business partners, and customers. The increase in business conducted on the Internet has been accompanied by an increasing concern about protecting information stored or communicated on the Internet from “hackers” who can gain unauthorized access to this information and either use it for their own financial benefit or compromise the information or the system on which it is stored. Given the enormous volume of business conducted on the Internet and the corresponding value of that business, it is imperative that the objects (including code, documents and images—anything represented in digital form) that are stored and exchanged and the intellectual property contained within those objects are secure—i.e., they cannot be accessed by individuals or companies who have no right to them, they cannot be printed unless there is permission to do so, they cannot be edited except where that right has been conferred by the owner.

Protection of objects and object exchanges may have many components. One of these, authentication, is the process of verifying the identity of a party requesting or sending information. This is generally accomplished through the use of passwords. A drawback to this approach is that passwords can be lost, revealed, or stolen.

A stricter authentication process uses digital certificates authorized by a certificate authority. A digital certificate contains the owner's name, serial number, expiration dates, and the digital signature (data appended to a message identifying and authenticating sender and message data using public key encryption (see below)) of the issuing authority. The certificate also contains the certificate owner's public key. In public key cryptography, which is widely used in authentication procedures, individuals have public keys and private keys which are created simultaneously by the certificate authority using an algorithm such as RSA. The public key is published in one or more directories containing the certificates; the private key remains secret. Messages are encrypted using the recipient's public key, which the sender captures in a directory, and decrypted using the recipient's private key. To authenticate a message, a sender can encrypt a message using the sender's private key; the recipient can verify the sender's identity by decrypting the signature with the sender's public key.

Authorization determines whether a user has any privileges (viewing, modifying, etc.) with regard to a resource. For instance, a system administrator can determine which users have access to a system and what privileges each user has within the system (i.e., access to certain files, amount of storage space, etc.). Authorization is usually performed after authentication. In other words, if a user requests access to an object, the system will first verify or authenticate the identity of the user and then determine whether that user has the right to access the object and how that user may use the object.

Encryption may also be used to protect objects. Encryption converts a message's plaintext into ciphertext. In order to render an encrypted object, the recipient must also obtain the correct decryption key (see, for instance, the discussion of the public key infrastructure and public key cryptography above). Although it is sometimes possible to “break” the cipher used to encrypt an object, in general, the more complex the encryption, the harder it is to break the cipher without the decryption key. A “strong” cryptosystem has a large range of possible keys which makes it almost impossible to break the cipher by trying all possible keys. A strong cryptosystem is also immune from previously known methods of code breaking and will appear random to all standard statistical tests.

Other types of security to protect the entire computer system may also be employed at the computer locations. For instance, many businesses set up firewalls in an attempt to prevent unauthorized users from accessing the business' data or programs. However, firewalls can be compromised and do not guarantee that a computer system will be safe from attack. Another problem is that firewalls do not protect the system or the system's resources from being compromised by a hostile user located behind the firewall.

Transmission of messages can also be secured. Transport Layer Security (TLS) and Secure Sockets Layer (SSL) protocols are commonly used to provide encrypted communications between servers and clients. Both these protocols are incorporated into most Web browsers and servers.

The above-mentioned security devices may be used separately, or more commonly, in some combination. In addition to these general devices, there are other approaches to security in the prior art.

U.S. Pat. No. 6,041,411 “Method for Defining and Verifying User Access Rights to Computer Information” discloses a method for authenticating and authorizing access rights to electronically transmitted information. A user requests information which the provider wraps with digital information, or instructions, which must successfully be answered before the rest of the information can be accessed. The “answer” to these instructions takes the form of a digital token which is associated with validly requested data and indicates whether access to the information is authorized. The information may be accessed upon “unwrapping” only if the token is present and indicates the user may access the information. This patent is primarily concerned with ensuring the authorized use of software programs purchased on-line and electronically transmitted to a user.

InterTrust Technologies Corporation has received several patents related to their digital rights management technology. InterTrust's Digibox container technology enables the encryption and storage of information, including content and rules regarding access to that content, in a Digibox container, essentially a software container. Once the information is stored in a Digibox container, that information may be viewed only by Intertrust software. Keys are passed with the encrypted data.

There is a need for an invention that will protect objects (basically, anything which may be represented in digital form), including code, documents, images, and software programs, that are available on the Internet without requiring authorized requesters to run special software on their computers in order to access protected information. (For instance, students are often on a limited budget and, even if they have their own computers, cannot reasonably be expected to buy extra software which would enable them to download information like course notes, schedules, etc. that schools are increasingly making available to authorized users over the Internet.) Additional desirable features for a digital rights management system include passing most of the protection “duties” to a third party in order to relieve the object server of the processing burden of providing security and providing one-time encryption keys that are securely passed between the requester and the “security server” rather than passing the encryption keys with the encrypted data. It is also desirable for a digital rights management system to offer protection to an object even after the object has been sent to the requester.

### SUMMARY OF THE INVENTION

This invention provides a method and system for protection of objects (anything represented in digital form, i.e., code, documents, images, software programs, etc.) distributed over a network. Protection denotes restricting certain operations (i.e., viewing, printing, editing, copying) on the objects by certain recipients.

An object server containing objects, both protected and unprotected, is equipped with software that designates whether an object should be protected and, if so, what the security policy (type and degree of protection the object should receive) is. The security policy may include restrictions on who may view the object, the lifetime of the object, the number of times the object may be viewed, as well as actions policies relating to actions such as whether the object may be printed, edited, etc. Object controls are mechanisms which implement the security policy.

When the object server receives a request for an object, the software checks whether the requested object is protected. If the object is unprotected, the server will send the object to the requester. If the object is protected, the software creates a new object which includes authentication and time of the original request as well as serialization, nonce, security policy, and description of the requested object; all of these are encrypted. The new object is sent back to the requesting browser in a reply, along with a redirect command that points the requesting browser to a “security server.”

After the security server, which is equipped with software for providing protection services, receives and authenticates the redirected request, it obtains the requested object either from its own cache or from the server containing the object via a secure transmission. The security server then encrypts the requested object (using strong and non-malleable encryption) and combines it with mobile code (software sent from remote systems, transferred across a network, and downloaded and executed on a local system without explicit installation or execution by the recipient), the security policy, and object controls. This resulting package is sent back to the requesting computer as a reply to the redirected request.

The requesting computer then tries to execute the mobile code in order to render the requested object. The mobile code will execute tests to ensure proper instantiation of the object controls; when these controls are properly instantiated, the requester may request a decryption key which is sent via secure transmission to the requester upon satisfactory authentication of the request. The decryption keys are one-time keys which may be used only for decrypting the specific object in question. If the mobile code executes successfully and a decryption key is obtained, the requested object is rendered subject to the constraints of the security policy and object controls.

The security server is used to execute most of the activities associated with protecting and delivering the requested object. Therefore, the object server is not spending processing resources on security issues and instead is dedicated to handling requests for information. In addition, all set-up time and maintenance for the security server is handled by that server's system administrators, resulting in further savings to the owners of the object servers.

This method and system differ from other object protection methods and systems in that common software does not need to be installed on all computers involved in the request and provision of a requested object. In addition, the keys used to encrypt/decrypt the object are one-time keys and are not passed with the encrypted object.

### BRIEF DESCRIPTION OF THE DRAWINGS

FIG. 1 is a block diagram of the components of an object protection system in accordance with the invention.

FIG. 2a is a flow chart showing how an object is protected in accordance with the invention.

FIG. 2b is a flow chart showing how an object is protected in accordance with the invention.

### DETAILED DESCRIPTION

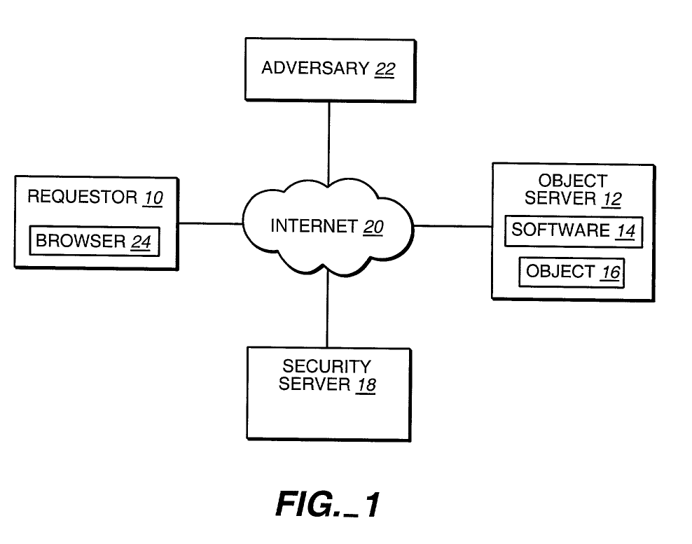

With reference to FIG. 1, a requester device 10 (in this embodiment, the device is a computer; however, the device includes anything that can act as a client in a client/server relationship), an object server 12, containing objects 16 and protection software 14 which designates whether objects are to be protected, and a security server 18 containing software 94 for providing protection services are all connected to a network, in this embodiment, the Internet 20. An object 16 includes anything which may be represented in digital form, such as code, a document, an image, a software program, etc. An adversary 22, a person or device such as a computer or recorder which may be used to gain unauthorized access to a protected object, may also be present. Although a single requester device 10, object server 12, and security server 18 are discussed here, it is envisioned that this method and system will accommodate a plurality of requester devices 10, object servers 12, and security servers 18.

In this embodiment, the object server 12 and the security server 18 are Hypertext Transfer Protocol (http) servers. The requester device 10 should be running a software program acting as a World Wide Web browser 24. Requests for objects 16 from the requester device 10 are relayed by the browser 24 to the object server 12 via http requests. Similarly, replies to requests conform to the http protocol.

As noted above, the object server 12 is running protection software 14, which in this embodiment is an extension of http server software. This protection software 14 is used by an authorized system administrator to designate which objects 16 are unprotected and which are to be protected. If an object 16 is designated as protected, the protection software 14 also allows the administrator to specify the type and degree of protection (i.e., the security policy) for the object 16. The security policy may include restrictions on who may view the object, the lifetime of the object (i.e., temporal restrictions), the number of times the object may be viewed (i.e., cardinal restrictions), as well as actions policies relating to whether the object may be printed, edited, etc. The actions that the requester may perform on an object may vary depending on the identity of the requester. Object controls are mechanisms which implement the security policy.

The security server 18 is also running software 94 which is an extension of http server software. This software 94 provides the protection services for objects.

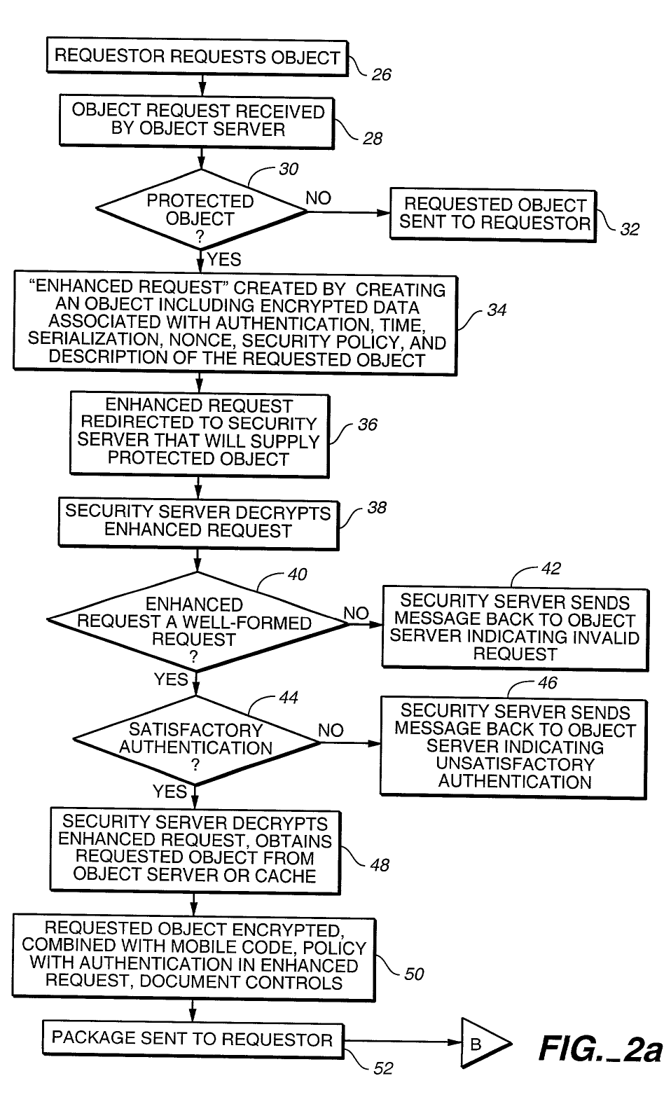

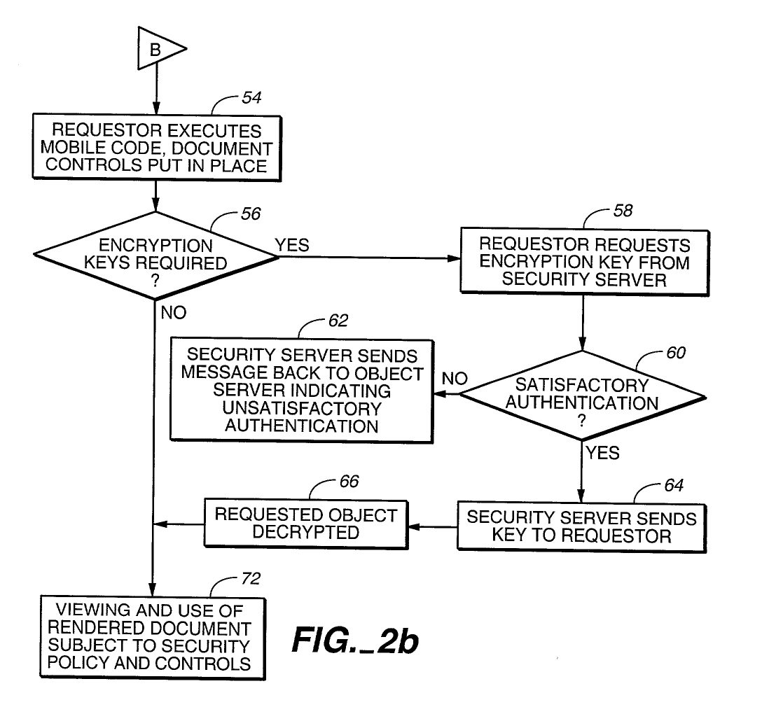

In FIG. 2, a requester requests an object (step 26). The object server storing the requested object receives the request (step 28). If the object server has an independent authentication policy, the object server will execute that policy and authenticate the request upon receipt. The protection software examines the http request to determine whether the request is for a protected object (step 30). If the requested object is not protected, the requested object is sent to the requester (step 32).

However, if the object is protected (step 30), the protection software creates an enhanced request (step 34) that is included in a reply to the request and is subsequently redirected to the security server (step 36). The enhanced request is an object comprising encrypted data including authentication and time of the original request as well as serialization (ensuring only one approved version of an object is available), nonce, security policy, and a description of the requested object. (Information about authentication depends on whether the object server has an independent authentication policy. If there is an authentication policy, the enhanced request includes the result of the authentication. If there is no authentication policy, that information is also included in the enhanced request.)

Encryption provides a variety of services. It can protect the integrity of a file (i.e., prevent unauthorized alterations) as well as assisting with the authentication and authorization of a request. The use of encryption here can also protect the privacy of the requester. Other uses for encryption include nonrepudiation and detecting alterations. Protocols supporting both strong and non-malleable encryption are used. (Protocols determine the type of encryption used and whether any exchanges between the requester and security server are necessary before encryption takes place (for example, a key many need to be exchanged so the recipient can decrypt an object encrypted at the server).)

The enhanced request is included in the reply to the requester along with a command to redirect the request to the security server. This redirection should be transparent to the requestor.

The security server software decrypts the enhanced request (step 38). A shared key for encrypting/decrypting the enhanced request is present at the object server and the security server. The key is generated when the software is installed on the object server.

The security server software then checks whether the enhanced request meets the requirements for a well-formed request (step 40). If the requirements for a well-formed request are not met, the security server sends a message back to the object server indicating an invalid request (step 42). (The object server may then send a message to the requester about the invalid request. The system administrator for the object server determines whether these messages will be sent.)

If the request is valid, the security server software next authenticates the request (step 44). The security server software will compare the time and authentication in the redirected request heading with those contained in the enhanced request. If the security server software cannot authenticate the request (for instance, the two request times differ such that a replay attack is indicated or the identity of the requester in the redirected request differs from the identity of the requester in the enhanced request), a message is sent back to the object server indicating unsatisfactory authentication (step 46). If the request is authenticated, the security server software decrypts the request and obtains the requested object either from the security server's cache or the object server (step 48). (The protection software will pass the object on to the security server upon request.) If the security server has to obtain the object from the object server, the object is passed via a secure transmission.

Once the security server has the requested object, the security server software encrypts it using protocols for strong encryption and non-malleable encryption and combines the object with mobile code (software sent from remote systems, transferred across a network, and downloaded and executed on a local system without explicit installation or execution by the recipient), a security policy with authentication contained in the enhanced request, and object controls (step 50). Encryption of the requested protected object serves to protect the object, its requester, and the provider by ensuring integrity, privacy, authentication (where appropriate), and authorization as well as being a tool for non-repudiation (i.e., a party to a transaction cannot falsely deny involvement in that transaction) and detecting alterations. The resulting package is then sent to the requester (step 52; see step B, FIG. 2b).

In FIG. 2b, the requester receives the reply and attempts to execute the mobile code (step 54). Upon execution of the mobile code, the security policy and object controls for the requested object are instantiated on the requestor's computer (step 54). The mobile code executes tests to determine whether the object controls were correctly instantiated. If so, if the requester needs a decryption key (step 56), the requester may request it from the security server (step 58). The security server software authenticates the request (step 60). If it cannot authenticate the request, a message to that effect is sent to the object server (step 62). However, if the message is authenticated, the security server software sends the requested key back to the requester (step 64) via a secure transmission, and the requested object is decrypted (step 66). The key used by the security server to encrypt/decrypt the object is a one-time key. The “seed” for randomly generating the one-time key is determined at the installation of security server software.

Once the mobile code is executed, the requester may view the object subject to any constraints imposed on the object by the security policy or object controls (step 68).

1. In a communications network, a system for protecting objects, said system comprising:
a) an object server running a software program which designates:
i) what objects among a set of objects on the object server are to be protected; and
ii) a security policy for protected objects, said object server connected to a network;
b) a requester device requesting a protected object from the object server, said device connected to the network; and
c) a security server running another software program providing protection services for objects designated by the software program as protected, said security server connected to the network, said software providing protection services including:
i) means for receiving a redirected, enhanced request for the requested protected object from the requester device, said enhanced request corresponding to the requester device's original request for the requested protected object and created by the object server;
ii) means for obtaining said requested protected object from a cache or from the object server on which the requested protected object is stored;
iii) means for encrypting said requested protected object;
iv) means for combining the requested protected object with mobile code, a security policy, and object controls; and
v) means for sending the resulting file to the requester device, said requester device having to execute the mobile code to render the requested object to the requester computer, a user of the requesting computer to use and view the object subject to the security policy and object controls that are put in place on the requesting computer upon execution of the mobile code; and
vi) means for verifying proper instantiation of the object controls; and
vii) means for providing a decryption key to the requester computer upon verification of proper instantiation of the object controls and satisfactory authentication of a request for said key.

2. The system of claim 1 wherein the encrypted data of the enhanced request includes authentication, time of original request, serialization, nonce, security policy, and description of the requested protected object.

3. The system of claim 1 wherein the device is a computer.

4. The system of claim 1 wherein the device is a client capable of requesting an object from the object server.

5. The system of claim 1 further including a plurality of servers containing additional objects among the set of objects.

6. The system of claim 1 further including a plurality of computers requesting objects among the set of objects.

7. The system of claim 1 further including a plurality of security servers.

8. The system of claim 1 including means for secure transmission of the requested protected object from the object server to the security server.

9. The system of claim 1 including means for secure transmission of the decryption key from the security server to the requester.

10. The system of claim 1 wherein the object server and the security server share an encryption key for encrypting and decrypting enhanced requests.

11. The system of claim 1 wherein the network is the Internet.

12. The system of claim 1 further including means for providing physical security at the object server.

13. The system of claim 12 wherein the means for providing physical security at the object server includes a firewall.

14. The system of claim 1 further including means for providing physical security at the security server.

15. The system of claim 14 wherein the means for providing physical security at the security server includes a firewall.

16. The system of claim 1 wherein the enhanced request is an object containing encrypted authentication of the original request.

17. The system of claim 1 wherein the enhanced request is an object containing encrypted time of the original request.

18. The system of claim 1 wherein the enhanced request is an object containing encrypted serialization of the original request.

19. The system of claim 1 wherein the enhanced request is an object containing encrypted nonce of the original request.

20. The system of claim 1 wherein the enhanced request is an object containing encrypted security policy of the original request.

21. The system of claim 1 wherein the enhanced request is an object containing encrypted description of the requested object.

22. The system of claim 1 further including a requestor device running a software program acting as a World Wide Web browser.

23. The system of claim 1 wherein the object server is a hypertext transfer protocol server.

24. The system of claim 1 wherein the security server is a hypertext transfer protocol server.

25. The system of claim 1 further including means for requesting and exchanging files according to hypertext transfer protocol, said means present on the requester computer, object server, and the security server.

26. The system of claim 1 wherein the software program running on the object server and the security server is an extension for a hypertext transfer protocol server.

27. The system of claim 1 further including an adversary device which may be used to try to gain unauthorized access to a protected object.

28. The system of claim 27 wherein the device is a computer.

29. The system of claim 27 wherein the device is a recorder.

30. The system of claim 1 wherein the security server creates a one-time encryption key for each protected object.

31. The system of claim 1 further including means for strong encryption.

32. The system of claim 1 further including means for non-malleable encryption.

33. In a communications network, a method for protecting objects, said method comprising:
a) receiving a request for a protected object from a requester device, said requester device attached to a network, said request received at a object server containing the requested protected object, said server connected to a network;
b) creating an enhanced request at the object server;
c) redirecting the enhanced request to a security server connected to the network, said security server running software providing protection services for objects contained on the object server, said protection services including:
i) encrypting the requested protected object according to a protocol;
ii) combining the requested protected object with mobile code, a security policy, and object controls; and
iii) authenticating the identity of the requester device;
d) decrypting the enhanced request;
e) obtaining the requested protected object, said object either stored in a cache of the security server or sent from object server to security server;
f) encrypting the requested protected object at the security server according to a protocol;
g) creating a package combining the encrypted requested protected object with items including mobile code, the security policy, and object controls, said package created at the security server;
h) sending the package to the requester device;
i) executing the mobile code combined with the package at the requester device in order to render the requested protected object, said requested protected object to be used and viewed in accordance with the security policy and object controls associated with said requested protected object, said security policy and object controls put in place at the requester device upon execution of the mobile code, said mobile code performing tests to verify proper instantiation of object controls; and
j) decrypting the package at the requester device, said requester device requesting a decryption key from the security server if required, said security server providing the decryption key to the requester computer upon receipt of the request, satisfactory authentication, and satisfactory instantiation of object controls.

34. The method of claim 33 wherein object requests and exchanges conform to the hypertext transfer protocol.

35. The method of claim 33 wherein the redirecting step is contained in the reply to the requester device's request for the protected object.

36. The method of claim 33 wherein the redirecting step is transparent to a user of the requester device.

37. The method of claim 33 wherein the object is sent from the object server to the security server via a secure transmission.

38. The method of claim 33 wherein the decryption key is sent from the security server to the requester device via a secure transmission.

39. The method of claim 33 wherein the enhanced request is encrypted and decrypted by an encryption key shared by the object server and the security server.

40. The method of claim 33 wherein the enhanced request is an object including encrypted authentication of the original request for the requested object.

41. The method of claim 33 wherein the enhanced request is an object including encrypted time of the original request for the requested object.

42. The method of claim 33 wherein the enhanced request is an object including encrypted serialization of the requested object.

43. The method of claim 33 wherein the enhanced request is an object including encrypted security policy for the requested object.

44. The method of claim 33 wherein the enhanced request is an object including encrypted description of the requested object.

45. The method of claim 33 wherein a protocol including encryption for the requested protected object provides strong encryption.

46. The method of claim 33 wherein a protocol including encryption for the requested protected object provides non-malleable encryption.

47. The method of claim 33 wherein encrypting the enhanced request protects the privacy of a requester.

48. The method of claim 33 wherein encrypting the enhanced request retains the integrity of the enhanced request.

49. The method of claim 33 wherein encrypting the enhanced request retains the non-refutability of the enhanced request.

50. The method of claim 33 wherein encrypting the enhanced request retains the authentication of the enhanced request.

51. The method of claim 33 wherein encrypting the enhanced request retains the authorization of the enhanced request.

52. The method of claim 33 wherein a protocol including encryption for the enhanced request provides strong encryption.

53. The method of claim 33 wherein a protocol including encryption for the enhanced request provides non-malleable encryption.

54. The method of claim 33 wherein encrypting the requested protected object protects the privacy of a requester.

55. The method of claim 33 wherein encrypting the requested protected object retains the integrity of the requested protected object.

56. The method of claim 33 wherein encrypting the requested protected object retains the non-refutability of the requested protected object.

57. The method of claim 33 wherein encrypting the requested protected object retains the authentication of the requested protected object.

58. The method of claim 33 wherein encrypting the requested protected object retains the authorization of the requested protected object.

59. In a communications network, a method for protecting objects, said method comprising:
a) receiving a request for a protected object from a requester device, said requester device attached to a network, said request received at an object server containing the requested protected object, said object server connected to a network;
b) creating an enhanced request for the requested object at the object server; and
c) redirecting the enhanced request to a security server running software providing protection services for the requested object;
wherein the processing burden for protecting objects is shifted from the object server to the security server.

60. The method of claim 57 wherein an encryption protocol may be used to create the enhanced request.

61. The method of claim 60 wherein a protocol including encryption for the enhanced request provides strong encryption.

62. The method of claim 60 wherein a protocol including encryption for the enhanced request provides nonmalleable encryption.

63. The method of claim 59 wherein the enhanced request is an object including encrypted authentication of the original request for the requested object.

64. The method of claim 59 wherein the enhanced request is an object including encrypted time of the original request for the requested object.

65. The method of claim 59 wherein the enhanced request is an object including encrypted serialization of the requested object.

66. The method of claim 59 wherein the enhanced request is an object including encrypted security policy for the requested object.

67. The method of claim 59 wherein the enhanced request is an object including encrypted nonce for the requested object.

68. The method of claim 59 wherein the enhanced request is an object including encrypted description of the requested object.

69. The method of claim 59 wherein the redirecting step is transparent to a user of the requester device.

70. The method of claim 59 wherein the protection services provided by the security server include encrypting the requested protected object.

71. The method of claim 59 wherein the protection services provided by the security server include combining the requested protected object with mobile code, a security policy, and object controls.

72. The method of claim 71 wherein the protection services provided by the security server include providing a decryption key to the requester device upon an indication of proper instantiation of object controls and proper authentication of a request for a decryption key.

73. The method of claim 59 wherein encrypting the enhanced request protects the privacy of a requester.

74. The method of claim 59 wherein encrypting the enhanced request retains the integrity of the enhanced request.

75. The method of claim 59 wherein encrypting the enhanced request retains the non-refutability of the enhanced request.

76. The method of claim 59 wherein encrypting the enhanced request retains the authentication of the enhanced request.

77. The method of claim 59 wherein encrypting the enhanced request retains the authorization of the enhanced request.

78. The method of claim 59 wherein encrypting the requested protected object protects the privacy of a requestor.

79. The method of claim 59 wherein encrypting the requested protected object retains the integrity of the requested protected object.

80. The method of claim 59 wherein encrypting the requested protected object retains the non-refutability of the requested protected object.

81. The method of claim 59 wherein encrypting the requested protected object retains the authentication of the requested protected object.

82. The method of claim 59 wherein encrypting the requested protected object retains the authorization of the requested protected object.

83. In a communications network, a method for protecting objects that have been sent to requester device, said method comprising:
a) receiving a request at a server from a requester device for a protected object;
b) encrypting the requested protected object according to a protocol;
c) creating a package combining the encrypted, requested protected object with items including mobile code, a security policy, and object controls for the requested protected object at the server, wherein the requested protected object cannot be rendered until the mobile code is executed at the requester device;
d) sending the package from the server to the requester device;
e) executing the mobile code combined with the package at the requester device in order to render the requested protected object, said requested protected object to be used and viewed in accordance with the security policy and object controls associated with said requested protected object, said security policy and object controls put in place at the requester device upon execution of the mobile code, said mobile code performing tests to verify proper instantiation of object controls.

84. The method of claim 83 wherein a protocol including encryption for the requested protected object provides strong encryption.

85. The method of claim 83 wherein a protocol including encryption for the requested protected object provides non-malleable encryption.

86. The method of claim 83 wherein encrypting the requested protected object protects the privacy of a requester.

87. The method of claim 83 wherein encrypting the requested protected object retains the integrity of the requested protected object.

88. The method of claim 83 wherein encrypting the requested protected object retains the non-refutability of the requested protected object.

89. The method of claim 83 wherein encrypting the requested protected object retains the authentication of the requested protected object.

90. The method of claim 83 wherein encrypting the requested protected object retains the authorization of the requested protected object.

91. The method of claim 83 wherein the request received at the server is redirected from a first server storing the protected object.

92. The method of claim 83 wherein the request that is redirected and received by the server is an enhanced version of the request originally sent to the first server.

93. The method of claim 92 wherein the enhanced request is an object including encrypted authentication of the original request for the requested object.

94. The method of claim 92 wherein the enhanced request in an object including encrypted time of the original request for the requested object.

95. The method of claim 92 wherein the enhanced request is an object including encrypted serialization of the requested object.

96. The method of claim 92 wherein the enhanced request is an object including encrypted security policy for the requested object.

97. The method of claim 92 wherein the enhanced request is an object including encrypted description of the requested object.

98. The method of claim 92 wherein the enhanced request is an object including encrypted nonce for the requested object.

99. The method of claim 92 wherein encrypting the enhanced request protects the privacy of a requester.

100. The method of claim 92 wherein encrypting the enhanced request retains the integrity of the enhanced request.

101. The method of claim 92 wherein encrypting the enhanced request retains the non-refutability of the enhanced request.

102. The method of claim 92 wherein encrypting the enhanced request retains the authentication of the enhanced request.

103. The method of claim 92 wherein encrypting the enhanced request retains the authorization of the enhanced request.

104. The method of claim 92 further including the server providing the requestor computer with a decryption key upon satisfactory authentication of a request for said key.
